(19) United States
(12) Patent Application Publication
(10) Pub. No.: US 2015/0139475 A1
(43) Pub. Date: May 21, 2015

(54) SPEAKER DECORATIVE RIM MOUNTING STRUCTURE

(71) Applicant: Kai Shuai Industrial Co., Ltd., Taipei (TW)

(72) Inventor: I-Hsun YU, Taipei (TW)

(73) Assignee: Kai Shuai Industrial Co., Ltd., Taipei (TW)

(21) Appl. No.: 14/085,258

(22) Filed: Nov. 20, 2013

(51) Int. Cl. H04R 1/02

(52) U.S. Cl. CPC H04R 1/021
USPC 381/386

(57) ABSTRACT

A speaker decorative rim mounting structure includes a speaker body holding a speaker driver, a face panel assembly including an outer face panel mounted at the speaker body and an inner face panel mounted within the outer face panel and providing a retaining flange, and a decorative rim holding a metal mesh and having equiangularly spaced bottom hooks directly hooked on the retaining flange of the inner face panel to secure to the decorative rim to the face panel assembly.

### BACKGROUND OF THE INVENTION

1. Field of the Invention

The present invention relates to speaker technology, and more particularly to a decorative rim mounting structure used in a wall-mount speaker that enables a metal mesh equipped decorative rim to be installed in a wall-mount speaker in a convenient and low cost manner, forming a more enhanced and reliable structure.

2. Description of the Related Art

In order to provide a better sound output, the speakers of a stereo system are usually separated from the stereo headunit. When a stereo system of this kind is installed in a room, the speakers are normally placed on the floor. However, this installation method occupies much the floor area of the room. In addition to the consideration of saving the floor area, people may install the speakers in the wall or ceiling in order to obtain better audio sound output effects, or due to the considerations of audio broadcast live environment.

Unlike a cabinet-based floor-mount speaker, the structure of a wall-mount speaker must be relatively simple for easy installation. FIG. 1 illustrates a conventional wall-mount speaker, which comprises a speaker driver 10 having a vibratable cone 11, a face panel 12 mounted at the top side of the speaker driver 10, and a decorative rim 14 mounted at the face panel 12 and holding therein a metal mesh 13 to form a flat speaker surface and to shield the vibratable cone 11 of the speaker driver 10.

In conventional wall-mount speakers, magnetic attraction mounting design is normally used, i.e., magnetic components are used for the connection between the decorative rim 14 and the face panel 12. However, the use of the magnetic components relatively increases the speaker manufacturing cost. Further, the magnetic attraction structure is less reliable. If a wall-mount speaker is installed in a ceiling or any wall in a downward facing position, the decorative rim can fall from the face panel after a long use. Thus, a magnetic component-based mounting structure is not durable.

### SUMMARY OF THE INVENTION

The present invention has been accomplished under the circumstances in view. It is main object of the present invention to provide a speaker decorative rim mounting structure, which effectively reduces the manufacturing cost of the mounting structure.

It is another object of the present invention to provide a speaker decorative rim mounting structure, which facilitates quick mounting between the decorative rim and the speaker body in the factory.

It is still another object of the present invention to provide a speaker decorative rim mounting structure, which reinforces the structural strength between the decorative rim and the speaker body, prolonging the lifespan of the speaker.

To achieve these and other objects of the present invention, a speaker decorative rim mounting structure of the present invention comprises a speaker body holding a speaker driver therein, a face panel assembly mounted at the top side of the speaker body, and a decorative rim fastened to the inner face panel. The face panel assembly comprises an outer face panel mounted at said top side of the speaker body, and an inner face panel mounted within the outer face panel. The decorative rim comprises an inner perimeter defining a circular center opening, and a plurality of hooks extended from and equiangularly spaced around the inner perimeter thereof within the circular center opening. Further, the inner face panel comprises a retaining flange for engagement with the hooks of the decorative rim.

Preferably, the hooks of the decorative rim are downwardly curved from the inner perimeter of the decorative rim and respectively terminating in a hooked tip. Further, the inner face panel of the face panel assembly further comprises a tapered inner perimeter and axially extending outer perimeter joined with a part of the tapered inner perimeter. The retaining flange of the inner face panel is extended from the tapered inner perimeter over the top side of the axially extending outer perimeter.

Preferably, the axially extending outer perimeter of the inner face panel defines with the outer face panel a clearance, and the hooks of the decorative rim are inserted into the clearance and hooked up with the retaining flange of the inner face panel.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of a conventional wall-mount speaker.

FIG. 2 is a top elevational view of a speaker decorative rim mounting structure in accordance with the present invention.

FIG. 3 is an exploded view of the speaker decorative rim mounting structure in accordance with the present invention.

FIG. 3A is an enlarged view of a part of the inner face panel shown in FIG. 3.

FIG. 3B is an enlarged view of a part of the decorative rim shown in FIG. 3.

FIG. 4 is a sectional view of the speaker decorative rim mounting structure in accordance with the present invention.

FIG. 5 is an enlarged view of Part C of FIG. 4.

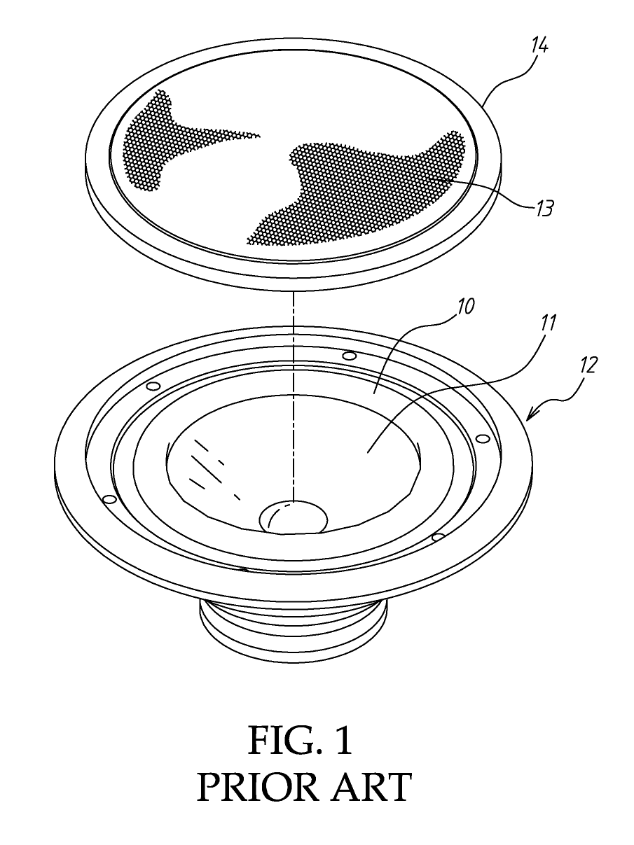

### DETAILED DESCRIPTION OF THE PREFERRED EMBODIMENT

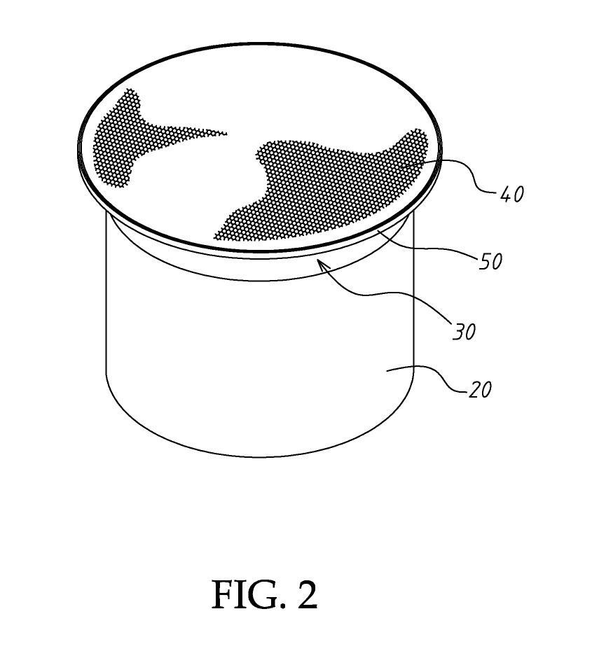

Referring to FIG. 2, a speaker decorative rim mounting structure in accordance with the present invention is shown. The speaker decorative rim mounting structure comprises a speaker body 20, a face panel assembly 30 located at one side, namely, the top side of the speaker body 20, and a decorative rim 50 mounted on the surface of the face panel assembly 30 and carrying therein a metal mesh 40.

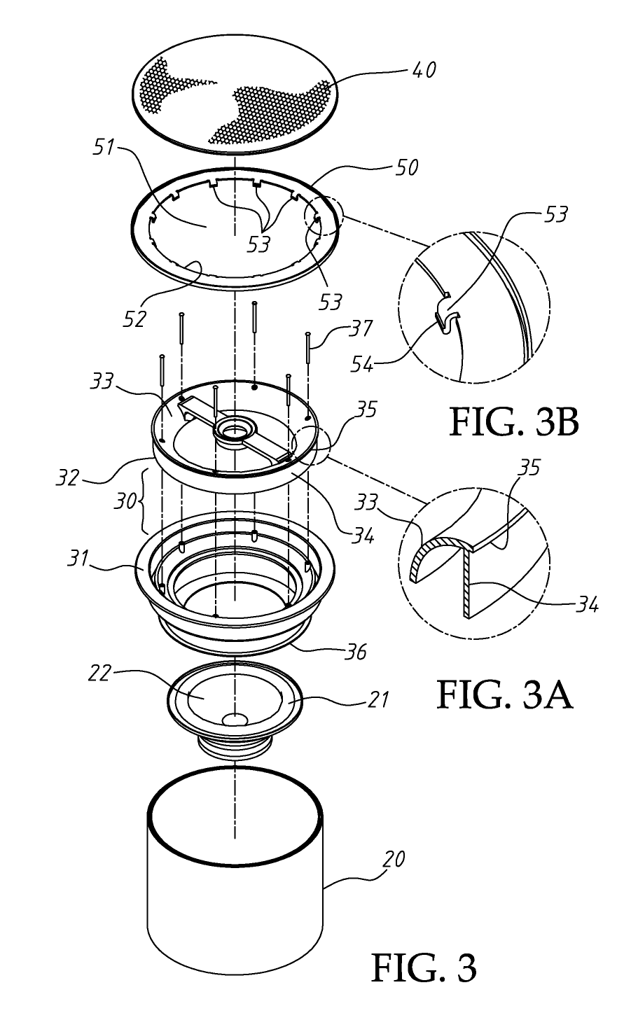

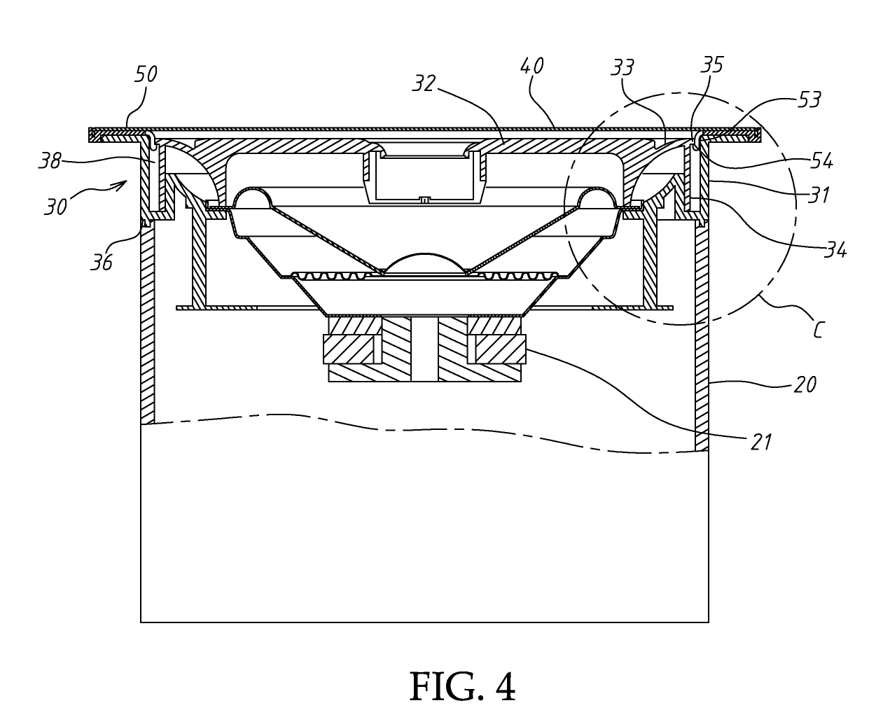

Referring to FIGS. 3 and 4, the speaker body 20 has a speaker driver 21 mounted therein. The face panel assembly 30 comprises an outer face panel 31 mounted at topmost edge of the speaker body 20, and an inner face panel 32 mounted within the outer face panel 31 and carrying therein a treble amplifier. The decorative rim 50 is assembled with the metal mesh 40 to shield the vibratable cone 22 of the speaker 21. The outer face panel 31 is a hollow panel having a bottom mounting flange 36 fastened to a mounting groove (see FIG. 4) in the top side of the speaker body 20. The inner face panel 32 is affixed to the inside of the outer face panel 31 with screws 37, defining a clearance 38 between the outer perimeter of the inner face panel 32 and the outer face panel 31 (see FIG. 4). The main feature of the present invention is that the decorative rim 50 comprises a hook structure; the face panel assembly 30 comprises gripping means for securing the hook structure of the decorative rim 50 directly and rapidly.

According to the present preferred embodiment, the decorative rim 50 is a circular ring plate having a circular center opening 51 and a plurality of hooks 53 equiangularly spaced along the inner perimeter 52 thereof. In this embodiment, the hooks 53 are curved suspending members having a predetermined length and respectively terminating in a hooked tip 54 (see FIG. 3B). The inner face panel 32 of the face panel assembly 30 comprises a tapered inner perimeter 33, an axially extending outer perimeter 34, and a retaining flange 35 extended from the tapered inner perimeter 33 above the axially extending outer perimeter 34 for engagement with the hooks 53 of the decorative rim 50 (see FIG. 3A).

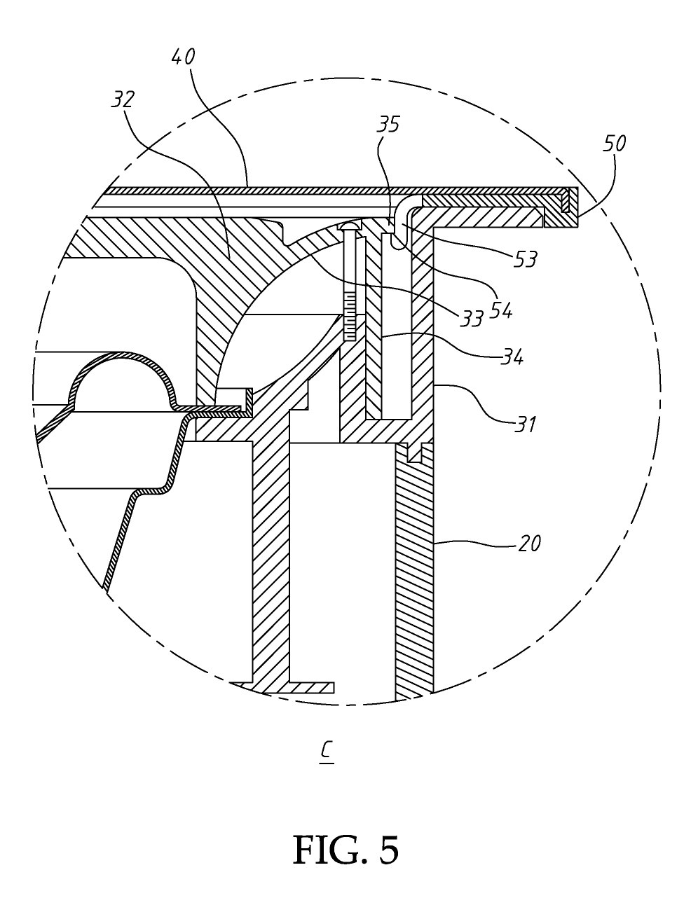

Referring to FIG. 5 and FIG. 4 again, after setting of the metal mesh 40 in the decorative rim 50, the decorative rim 50 is directly attached to the face panel assembly 30 by inserting the hooks 53 of the decorative rim 50 into the clearance 38 between the inner face panel 32 and the outer face panel 31 to force the hooked tips 54 of the hooks 53 into engagement with the retaining flange 35 of the inner face panel 32. Subject to the material properties of the decorative rim 50, the hooked tips 54 of the hooks 53 can be elastically deformed and moved over the top surface of the retaining flange 35 to the bottom side of the retaining flange 35 and then hooked up with the bottom surface of the retaining flange 35.

The speaker decorative rim mounting structure in accordance with the present invention eliminates the use of any magnetic materials, saving the speaker manufacturing cost. Simply by giving a downward pressure to the decorative rim relative to the face panel assembly, the decorative rim can then be rapidly installed. Further, the engagement between the hooks of the decorative rim and the retaining flange of the inner face panel also reinforce the structural strength of the whole structure, prolonging the speaker lifespan.

Although a particular embodiment of the invention has been described in detail for purposes of illustration, various modifications and enhancements may be made without departing from the spirit and scope of the invention. Accordingly, the invention is not to be limited except as by the appended claims.

1. A speaker decorative rim mounting structure, comprising:
a speaker body holding a speaker driver therein;
a face panel assembly having an outer face panel connected to a top of said speaker body and an inner face panel located in and connected to an interior of said outer face panel, the inner face panel having an inner perimeter being tapered, an outer peripheral wall extending axially, and a retaining flange defining an outer perimeter thereof, said retaining flange extends outwardly from said inner perimeter and is located above said outer peripheral wall; and
a rim fastened to said inner face panel, the rim having an inner perimeter defining a center opening being circular, and a plurality of hooks extending downwardly from and equiangularly spaced around the inner perimeter of the rim within said center opening; said plurality of hooks engaging said retaining flange of said inner face panel.

2. The speaker decorative rim mounting structure as claimed in claim 1, wherein each hook of said plurality of hooks of said decorative rim are downwardly curved from the inner perimeter of said decorative rim and respectively terminating in a hooked tip.

3. The speaker decorative rim mounting structure as claimed in claim 2, wherein a clearance is defined by a space located between said outer peripheral wall of said inner face panel and said outer face panel; said plurality of hooks of said rim are inserted into said clearance and each hooked tip of said plurality of hooks engaging said retaining flange of said inner face panel.

4. The speaker decorative rim mounting structure as claimed in claim 3, wherein said plurality of hooks are located between said inner face panel and said outer face panel of said face panel assembly.

5. The speaker decorative rim mounting structure as claimed in claim 3, wherein said speaker driver is fixed between said inner face panel and said outer face panel of said face panel assembly.

6. The speaker decorative rim mounting structure as claimed in claim 1, further comprising a metal mesh connected to a top of the rim.
